(19) United States
(12) Patent Application Publication
(10) Pub. No.: US 2011/0140673 A1
(43) Pub. Date: Jun. 16, 2011

(54) Pulse width modulated battery charging

(75) Inventors: Weibiao Zhang, Plano, TX (US); Mark A. Hamlett, Richardson, TX (US); J. Randall Cooper, Lucas, TX (US)

(73) Assignee: Texas Insturments Incorporated, Dallas, TX (US)

(21) Appl. No.: 12/653,212

(22) Filed: Dec. 10, 2009

(51) Int. Cl. H02J 7/00

(52) U.S. Cl. 320/145; 320/163

(57) ABSTRACT

A battery management system for charging a battery by a charger includes a transistor and either a charge pump or a push-pull output driver. The transistor increases and decreases an electrical connection between the battery and a voltage from the charger and transmits a charge current from the charger to the battery by turning on and off in response to a pulse width modulated drive signal generated by the charge pump or the push-pull output driver. The charge pump or the push-pull output driver increases the drive signal when the voltage from the charger is above a pre-charge threshold voltage and decreases the drive signal when the voltage from the charger is below the pre-charge threshold voltage.

### BACKGROUND OF THE INVENTION

Some electronic devices 100 that operate with a rechargeable battery 102 have a battery management system 104 between a charger 106 and the battery 102 for controlling the charging, and sometimes the discharging, of the battery 102, as shown in a simplified prior art schematic diagram in FIG. 1. The battery management system 104 usually includes a battery management system chip 108, with various internal integrated circuit components, along with a discharge FET 110, a charge FET 112 and a sense resistor 114 external to the battery management system chip 108.

The control enabled by the battery management system 104 can be essential for batteries that can overheat or become damaged due to improper charging techniques. For example, when a Li-Ion (Lithium-Ion) battery is fully, or almost fully, discharged, the charge current applied to it during recharging must be considerably smaller than the charge current that can be applied when the battery still has most of its charge. Otherwise, if a relatively high charge current is applied to a fully discharged Li-Ion battery, the battery may overheat and become damaged and/or can damage other nearby components.

Consequently, such batteries are typically charged in at least two stages or modes: a pre-charge mode and a fast-charge mode. In the pre-charge mode, a relatively low pre-charge current is usually applied to the battery 102. In the fast-charge mode, a higher fast-charge current, sometimes as much as ten times higher than the pre-charge current, is usually applied to the battery 102. The cutoff point between the pre-charge mode and the fast-charge mode is commonly called the “fast-charge threshold voltage.” The fast-charge threshold voltage is determined by the voltage level of either the voltage of the battery 102 (at node BAT) or the voltage from the charger 106 (at node PACKP), which is pulled down by the battery 102 when electrically connected thereto by the FETs 110 and 112.

Typically, the charger 106 is designed to sense when its output voltage (at node PACKP) is pulled down so low by the battery 102 (due to low battery charge) as to indicate that the pre-charging mode must be used. Thus, upon detecting that the voltage at PACKP is lower than the fast-charge threshold voltage, the charger 106 limits itself to generating the lower pre-charge current. And upon detecting that the voltage at PACKP is higher than the fast-charge threshold voltage, the charger 106 generates the higher fast-charge current. (Other chargers, such as some simple DC/DC converters, do not adjust their output current for the pre-charge mode, but only output a single current, so the battery management system 104 in these situations has to limit the current to the pre-charge current when necessary.) Additionally, the battery management system chip 108 is typically designed to sense when either the voltage at PACKP or the voltage at BAT indicates which of the pre-charging and fast-charging modes must be used.

Various different techniques have been used to control the pre-charge and fast-charge modes and the switching between modes. Some such techniques use a pre-charge transistor (not shown) and an external resistor (not shown) to bypass the charge FET 112 and apply the pre-charge current to the battery 102. The disadvantages of these techniques include the cost and space of the pre-charge transistor, the resistor and other necessary components to control the pre-charge transistor.

Some other techniques use the discharge FET 110 and the charge FET 112, without additional components external to the battery management system chip 108, to control the pre-charge mode. For example, tying the VCC and CHG nodes of the battery management system chip 108 (source and gate of the charge FET 112, respectively) together during the pre-charge mode would allow the charge FET 112 to turn on and the parasitic diode of the discharge FET 110 to be forward biased, so the pre-charge current from the charger 106 can charge the battery 102 when the voltage (at node BAT) of the battery 102 is very low. The disadvantage of this example is that if the voltage of the battery 102 is too low, e.g. almost zero, then it is very likely that the VCC will be pulled down below the minimum operating voltage of the battery management system chip 108, so the status of the battery 102 cannot be updated and battery-protection functions are not operational.

The additional details shown in the battery management system chip 108 in FIG. 1 illustrate another example prior art technique using the discharge FET 110 and the charge FET 112, without additional components external to the battery management system chip 108, to control the pre-charge mode. This technique is commonly referred to as Pulse Width Modulation (PWM) pre-charging, because it uses a voltage generated by a charge pump 116 and two switches 118 and 120 to turn on and off the charge FET 112 while leaving the discharge FET 110 on during the pre-charge mode. The outputs of two comparators 122 and 124 operate the switches 118 and 120, respectively, based on the voltage from the charger 106 (at node PACKP) compared to lower and upper threshold voltages V_1 and V_2, respectively.

The upper threshold voltage V_2 is selected to be greater than the lower threshold voltage V_1, as shown in FIG. 2. Additionally, both threshold voltages V_1 and V_2 are selected to be lower than the fast-charge threshold voltage V_fc and greater than the minimum operating voltage V_min of the battery management system chip 108.

When the voltage at PACKP (V_packp) is above the upper threshold voltage V_2, the functions of the comparators 122 and 124 and the switches 118 and 120 cause the output of the charge pump 116 to connect to CHG (FIG. 1) to increase the voltage at CHG (V_chg, FIG. 2) and turn on the charge FET 112. On the other hand, when the voltage at PACKP (V_packp) is below the lower threshold voltage V_1, the functions of the comparators 122 and 124 and the switches 118 and 120 cause ground 126 to connect to CHG to decrease the voltage at CHG (V_chg) and turn off the charge FET 112. The turning on and off of the charge FET 112 causes the voltage from the charger at PACKP to be electrically connected to and disconnected from, respectively, the battery 102 at BAT, so the voltage at PACKP (V_packp) is pulled down and up, respectively, by the battery 102 and the charger 106, respectively. This cycle repeats as long as the voltage of the battery 102 (V_batt) is low enough to pull the voltage at PACKP below the lower threshold voltage V_1, as illustrated by simplified voltage and current graphs in FIG. 2.

It is desirable to have the battery charging process enter the fast-charge mode (at time T5) as soon as possible, because the higher fast-charge current can charge the Li-Ion battery faster than the lower pre-charge current can. For this reason, makers of batteries and battery management systems have attempted to make the fast-charge threshold voltage as low as possible. This trend has effectively “squeezed” V_1 and V_2 into a narrower and narrower range between V_fc and V_min. However, there are inevitable response delay times in the comparators 122 and 124, the switches 118 and 120 (and high voltage level shifters, not shown, used to turn on and off the switches 118 and 120) and the charge FET 112, as well as a finite drive capability of the charge pump 116. These response delay times and the ever decreasing range for V_1 and V_2 lead to ever higher power consumption requirements and manufacturing tolerance requirements for these components in order to drive these components as rapidly as possible to prevent the voltage at PACKP (V_packp) from overshooting V_1 and V_2 by too great of a margin.

The simplified voltage and current graphs in FIG. 2 illustrate a severe weakness of PWM pre-charging when the components 112 and 118-124 are not driven sufficiently rapid. (It is noted that the graphs in FIG. 2 do not represent a real-world time scale for a battery charging procedure that uses PWM pre-charging, but have been simplified in order to more clearly illustrate certain aspects of the procedure. For instance, the pitch between cycles for the V_packp, V_chg and charge current between times T2 and T3 are exaggerated. And the V_chg graph has been smoothed out and idealized after time T3.)

If the components 112 and 118-124 are not driven sufficiently rapid, the voltage at PACKP (V_packp) may not only overshoot V_2, but also overshoot the fast-charge voltage threshold V_fc, as shown, in each on/off cycle of the charge FET 112. The V_packp would thus be limited only by the maximum output voltage (V_max) of the charger 106. This cycling may continue during the time from the start of the pre-charging mode (at time T2) to the time at which the voltage of the battery 102 (V_batt) rises to the level of the lower threshold voltage V_1 (at time T3), at which time the outputs of the comparators 122 and 124 cease to cycle back and forth, because the voltage of the battery 102 no longer pulls the voltage at PACKP (V_packp) below V_1. Each time the V_packp overshoots V_fc, however, the battery charging procedure inappropriately enters the fast-charging mode, so the charge current rises to the fast-charge level (I_fc), only to drop back to the pre-charge level (I_pc) when the V_packp drops back below V_fc. The repeated application of the fast-charge current can cause the severe over-heating problems for the battery 102.

This cycling of the charge current, however, assumes that the charger 106 has the capability to re-enter the pre-charge mode after entering the fast-charge mode. Many commercially available chargers, though, do not have this capability, but will stay in the fast-charge mode once entering it, even if the V_packp drops back below the V_fc, thereby rendering the pre-charge mode completely ineffective.

Furthermore, if the components 112 and 118-124 are not driven sufficiently rapid, the voltage at PACKP (V_packp) may not only overshoot V_1 (on the down swing), but also risk overshooting the minimum operating voltage V_min of the battery management system chip 108 in each on/off cycle of the charge FET 112. If that situation were to happen, then the battery management system chip 108 would not be able to control the function of the battery management system 104.

It is, therefore, essential that the components 112 and 118-124 be driven sufficiently rapid to prevent the voltage at PACKP (V_packp) from overshooting the lower and upper threshold voltages V_1 and V_2 so far as to risk also overshooting the minimum operating voltage V_min of the battery management system chip 108 or the fast-charge voltage threshold V_fc. As design constraints push V_fc ever closer to V_min, however, the cost of manufacturing components that have an appropriate response time or delay period increases. Additionally, the power consumption of these components also continues to rise leading to a more expensive, less efficient battery charging system.

### BRIEF DESCRIPTION OF THE DRAWINGS

FIG. 1 is a simplified schematic diagram of a prior art electronic device having a prior art battery management system for charging a battery by a charger.

FIG. 2 is a simplified graph of voltages and a current at selected nodes in the simplified prior art schematic diagram shown in FIG. 1.

FIG. 3 is a simplified schematic diagram of an electronic device having a battery management system for charging a battery by a charger according to an embodiment of the present invention.

FIG. 4 is a simplified graph of voltages and a current at selected nodes in the simplified schematic diagram shown in FIG. 3 in accordance with an embodiment of the present invention.

FIG. 5 is a simplified schematic diagram of an alternative electronic device having an alternative battery management system for charging a battery by a charger according to another embodiment of the present invention.

FIG. 6 is a simplified schematic diagram of another alternative electronic device having another alternative battery management system for charging a battery by a charger according to yet another embodiment of the present invention.

### DETAILED DESCRIPTION OF THE INVENTION

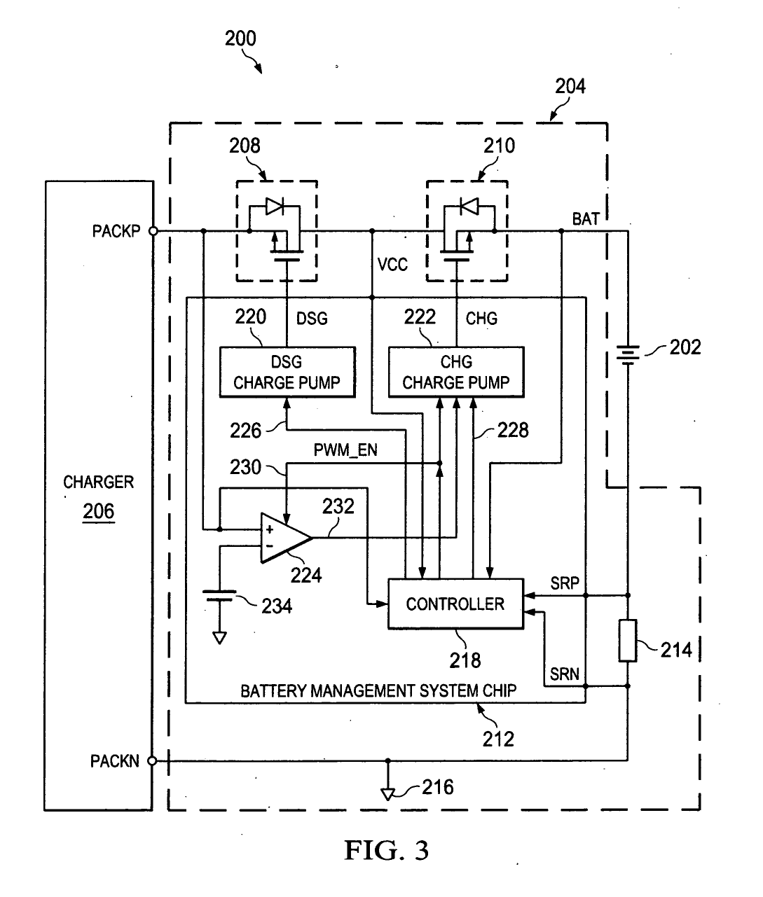

An example electronic device 200 (e.g. cell phone, PDA, MP3 player, notebook computer, etc.) that operates with a rechargeable battery 202 (such as a Li-Ion battery) under control of a battery management system 204 (incorporating an embodiment of the present invention) between a charger 206 and the battery 202 is shown in a simplified schematic diagram in FIG. 3. The battery management system 204 generally includes a discharge FET 208, a charge FET 210, a battery management system chip 212 and a sense resistor 214. The voltage (at PACKP) from the charger 206 is applied to the battery 202 (at BAT) through the discharge FET 208 and the charge FET 210 under control of the battery management system chip 212. Unlike in the prior art described above, however, the charge FET 210 is controlled by the battery management system chip 212 to turn on and off relatively slowly during the pre-charging mode. Thus, the electrical connection between the voltage (at PACKP) from the charger 206 and the battery 202 (at BAT) is increased and decreased, respectively, relatively slowly, which results in a relatively slow pulling down and pulling up, respectively, of the voltage (at PACKP) due to the battery 202 and the charger 206, respectively. The relatively slow decrease and increase of the voltage (at PACKP) from the charger 206 gives the battery management system chip 212 time to respond to the change in the voltage (at PACKP) and make the appropriate change to the charge FET 210 to maintain the voltage (at PACKP) with such a small ripple as to be “close” to a DC voltage. In this manner, the voltage (at PACKP) is held relatively steady within a very narrow range between the fast-charge threshold voltage of the battery 202 and the minimum operating voltage of the battery management system chip 212, without consuming excessive power to drive the charge FET 210 or requiring excessive tolerances in the manufacture of any of the components described herein.

The schematic diagram shown in FIG. 3 depicts a simplified version of the electronic device 200, so there may be many additional components of the electronic device 200 in addition to those shown and described herein. Furthermore, some of the additional components that are not shown may be placed in between some of the components that are shown without detracting from the invention. The following description, therefore, is representative only and is provided for illustrative purposes with the understanding that such additional components may subtly alter the real world functioning and characteristics of some the components shown and described herein.

According to the illustrated embodiment, a source line of the charger 206 at PACKP is generally connected to the drain of the discharge FET 208 and to the battery management system chip 212. The gate of the discharge FET 208 is connected to a “DSG” node of the battery management system chip 212. The source of the discharge FET 208 is connected to the VCC of the battery management system chip 212 and the source of the charge FET 210. The gate of the charge FET 210 is connected to a “CHG” node of the battery management system chip 212. The drain of the charge FET 210 is connected to the positive terminal of the battery 202 at BAT, which is also connected to the battery management system chip 212. The negative terminal of the battery 202 is connected to the positive end of the sense resistor 214, which is also connected to an “SRP” (sense resistor positive) node of the battery management system chip 212. The negative end of the sense resistor 214 is connected to an “SRN” (sense resistor negative) node of the battery management system chip 212, to ground 216 and to a return line of the charger 206 at PACKN.

When the battery management system chip 212 produces gate drive voltage signals at the DSG node and the CHG node, the discharge FET 208 and the charge FET 210, respectively, are turned on. For normal operation of the electronic device 200 with the charger 206 attached and the battery 202 fully charged, both the discharge FET 208 and the charge FET 210 are turned on to maintain the electrical connection from the charger 206 at PACKP to the battery 202 at BAT.

When the charger 206 is connected to the battery 202 through the FETs 208 and 210, the battery 202 generally pulls the voltage from the charger 206 down to the voltage level of the battery 202. When the battery 202 is fully charged, this voltage pull-down is insignificant. When the charge of the battery 202 is zero or very low, however, the battery management system chip 212 detects a low voltage either by the voltage of the battery 202 at BAT or by the pulled-down voltage from the charger 206 at PACKP (or at VCC). And in response, the battery management system chip 212 puts the battery management system 204 into the pre-charge mode to charge the battery 202. Additionally, since the voltage from the charger 206 at PACKP is pulled down to the level of the voltage of the battery 202, most chargers 206 (referred to herein as “smart” chargers) can sense this voltage level and adjust the output current accordingly to enter either the pre-charge mode or the fast-charge mode.

When the battery 202 is not fully charged, but the voltage either at BAT or PACKP is above a certain voltage level (referred to as the fast-charge threshold voltage), the battery management system chip 212 puts the battery management system 204 into the fast-charge mode to charge the battery 202 quickly. Additionally, if the charger 206 is a smart charger, the charger 206 senses the voltage at PACKP and outputs a relatively high fast-charge current. On the other hand, if the battery 202 is sufficiently discharged that the voltage at BAT, or at PACKP, is below the fast-charge threshold voltage, the battery management system chip 212 puts the battery management system 204 into the pre-charge mode, as described below, to charge the battery 202 (and to maintain the voltage at VCC above the minimum operating voltage of the battery management system chip 212) until conditions allow a switch to the fast-charge mode. Also, if the charger 206 is a smart charger, the charger 206 senses the lower voltage at PACKP and outputs a relatively low pre-charge current during the pre-charge mode. Furthermore, if the charger 206 is a smart charger, it is preferable for the charger 206 and the battery management system 204 to use approximately the same fast-charge threshold voltage in order to best work together in the pre-charge and fast-charge modes.

In the fast-charge mode, the battery management system chip 212 preferably maintains the gate drive voltage signals at both the DSG node and the CHG node at full power, so the maximum available voltage from the charger 206 can be applied to the battery 202 to charge the battery 202 as quickly as possible. In the pre-charge mode, on the other hand, the battery management system chip 212 preferably maintains the gate drive voltage signal at the DSG node at full power, but increases and decreases the gate drive voltage signal at the CHG node in response to the level of the voltage from the charger 206 at PACKP. In other words, the discharge FET 208 is maintained fully on to allow current from the charger 206 to pass at maximum capacity. But the gate drive voltage of the charge FET 210 is ramped up and ramped down, as described below.

In pre-charge mode, when the voltage from the charger 206 is initially applied at PACKP, the battery management system chip 212 detects that the voltage at PACKP is above another certain level (referred to herein as the pre-charge threshold voltage), so the battery management system chip 212 applies the gate drive voltage signal at the CHG node. (The pre-charge threshold voltage is below the fast-charge threshold voltage and above the minimum operating voltage of the battery management system chip 212.) As a result, the electrical connection increases through the charge FET 210 between the charger 206 at PACKP and the battery 202 at BAT. If the voltage of the battery 202 at BAT is below the pre-charge threshold voltage, then when the electrical connection increases between PACKP and BAT, the voltage at PACKP is pulled down by the battery 202 towards the voltage level of the battery 202 until the voltage at PACKP is below the pre-charge threshold voltage, but still above the minimum operating voltage of the battery management system chip 212. Then when the battery management system chip 212 detects that the voltage at PACKP is below the pre-charge threshold voltage, the battery management system chip 212 decreases the gate drive voltage signal at the CHG node. Thus, the electrical connection decreases through the charge FET 210 between the charger 206 at PACKP and the battery 202 at BAT, thereby decreasing the effect of the voltage of the battery 202 on the voltage at PACKP. Consequently, the charger 206 pulls up the voltage at PACKP towards the maximum output voltage level of the charger 206 before the voltage at PACKP (and consequently at VCC) falls below the minimum operating voltage of the battery management system chip 212.

However, as the battery management system chip 212 detects that the voltage at PACKP crosses back above the pre-charge threshold voltage, the battery management system chip 212 again increases the gate drive voltage signal at the CHG node, with the consequent results repeating. The battery management system 204, therefore, cycles through increasing and decreasing the gate drive voltage signal at the CHG node, increasing and decreasing the electrical connection through the charge FET 210 and correspondingly decreasing and increasing the voltage at PACKP below and above the pre-charge threshold voltage until the voltage of the battery 202 rises above the pre-charge threshold voltage. When the voltage of the battery 202 has risen above the pre-charge threshold voltage, the battery management system chip 212 no longer detects that the voltage at PACKP is below the pre-charge threshold voltage, so the battery management system chip 212 maintains the gate drive voltage signal at the CHG node at maximum level.

The net effect during the pre-charge mode, when the voltage of the battery 202 is below the pre-charge threshold voltage, is to maintain the voltage at PACKP within a relatively small range above and below the pre-charge threshold voltage that is below the fast charge threshold voltage. This voltage level is maintained without having to drive the charge FET 210 as rapidly as was required in the prior art described above due to the components and operation of the battery management system chip 212 described below.

Among other components (not shown), the battery management system chip 212 generally includes a controller 218, a DSG (discharge) charge pump 220, a CHG (charge) charge pump 222 and a comparator 224, in accordance with some embodiments of the present invention. The outputs of the DSG charge pump 220 and the CHG charge pump 222 are connected to the DSG node and CHG node, respectively. The input voltage from the charger 206 at PACKP is supplied to the comparator 224. Additionally, according to some embodiments, the controller 218 receives the input voltage signals (or converted digital data indicative of the voltages) from the charger 206 at PACKP (or at VCC), from the SRP and SRN nodes and from the battery 202 at BAT. (The sense resistor 214 in series with the battery 202 is used to sense the current and provide a voltage between SRP and SRN, which is used further for protecting the battery 202 from over-charging or over-discharging.)

The controller 218 may be any appropriate application-specific integrated circuit or programmable general purpose micro-controller capable of the functions, or having the features, described herein. In response to the inputs thereto, the controller 218 controls the operation of the battery management system 204, including the battery management system chip 212. In some embodiments, the controller 218 produces enable signals 226 and 228 to control the DSG charge pump 220 and the CHG charge pump 222, respectively. Additionally, the controller 218 produces a pulse width modulation enable (PWM_EN) signal 230 to control the comparator 224 and the CHG charge pump 222 for pulse width modulation during the pre-charging mode. Also, In response to the PWM_EN signal 230, the comparator 224 outputs a control signal 232 (based on the voltage at PACKP and a reference voltage 234 set to the level of the pre-charge threshold voltage), which also controls the pulse width modulation of the CHG. charge pump 222, as described below.

The DSG charge pump enable signal 226 is asserted by the controller 218 when the controller 218 determines that the voltage of the battery 202 is sufficient for operation of the electronic device 200 or when the voltage at PACKP indicates that the charger 206 is attached and supplying power for the electronic device 200. In response to receiving the DSG charge pump enable signal 226, the DSG charge pump 220 turns on and outputs the DSG drive voltage at the DSG node to drive the gate of the discharge FET 208. On the other hand, when the voltage of the battery 202 has dropped too low (e.g. during operation of the electronic device 200 for a long time without the charger 206 attached), the controller 218 de-asserts the DSG charge pump enable signal 226 to turn off the discharge FET 208. With the discharge FET 208 turned off, the battery 202 cannot continue to discharge and power the electronic device 200. In this manner, the battery 202 is prevented from discharging so much as to lose its recharging capability.

According to some embodiments, assertion of the CHG charge pump enable signal 228 and the PWM_EN signal 230 by the controller 218 depend on whether fast-charge mode or pre-charge mode is to be used. The CHG charge pump enable signal 228, for instance, is asserted by the controller 218 when the charger 206 is attached for charging the battery 202 (and powering the electronic device 200) and the controller 218 determines that the voltage of the battery 202 at BAT indicates that the fast-charge mode is to be used for charging the battery 202. (Alternatively, the controller 218 may make this determination based on whether the voltage from the charger 206 at PACKP, after the FETs 208 and 210 have been turned on at least once and the voltage of the battery 202 has had a chance to pull down the voltage from the charger 206, indicates that the fast-charge mode is to be used.) In response to receiving the CHG charge pump enable signal 228, the CHG charge pump 222 outputs a CHG drive voltage at the CHG node to drive the gate of the charge FET 210 at its maximum drive voltage, so the charge FET 210 can quickly allow the maximum electrical connection between PACKP and BAT.

According to some embodiments, the controller 218 asserts the PWM_EN signal 230 when the controller 218 determines that the voltage of the battery 202 at BAT indicates that the pre-charge mode is to be used for charging the battery 202. The PWM_EN signal 230 activates the comparator 224 and the CHG charge pump 222. In response to the PWM_EN signal 230, the comparator 224 asserts the control signal 232 (e.g. outputs a logic high voltage) when the voltage at PACKP is greater than the reference voltage 234, which is set to the level of the pre-charge threshold voltage, and de-asserts the control signal 232 (e.g. outputs a logic low voltage) when the voltage at PACKP is less than the reference voltage 234. The control signal 232 is applied to the comparator 224.

When activated by the PWM_EN signal 230, the CHG charge pump 222 generates the CHG drive voltage at the CHG node only when the control signal 232 is asserted by the comparator 224. In other words, in the pre-charge mode, the CHG charge pump 222 increases the CHG drive voltage when the voltage at PACKP is greater than the pre-charge threshold voltage and decreases the CHG drive voltage when the voltage at PACKP is less than the pre-charge threshold voltage, as determined by the comparator 224.

Additionally, in some embodiments, the CHG charge pump 222 preferably has somewhat different characteristics in response to the PWM_EN signal 230 and the control signal 232 than it has in response to the CHG charge pump enable signal 228. In particular, whereas the CHG charge pump 222 responds to the CHG charge pump enable signal 228 by maximizing the CHG drive voltage as quickly as possible, the CHG charge pump 222 responds (by conventional means) to the PWM_EN signal 230 and the control signal 232 by more slowly increasing (and decreasing) the CHG drive voltage. In other words, the CHG charge pump 222 is used during pre-charging in a “regulated” mode in which it pulls up and pulls down the CHG drive voltage relatively gradually.

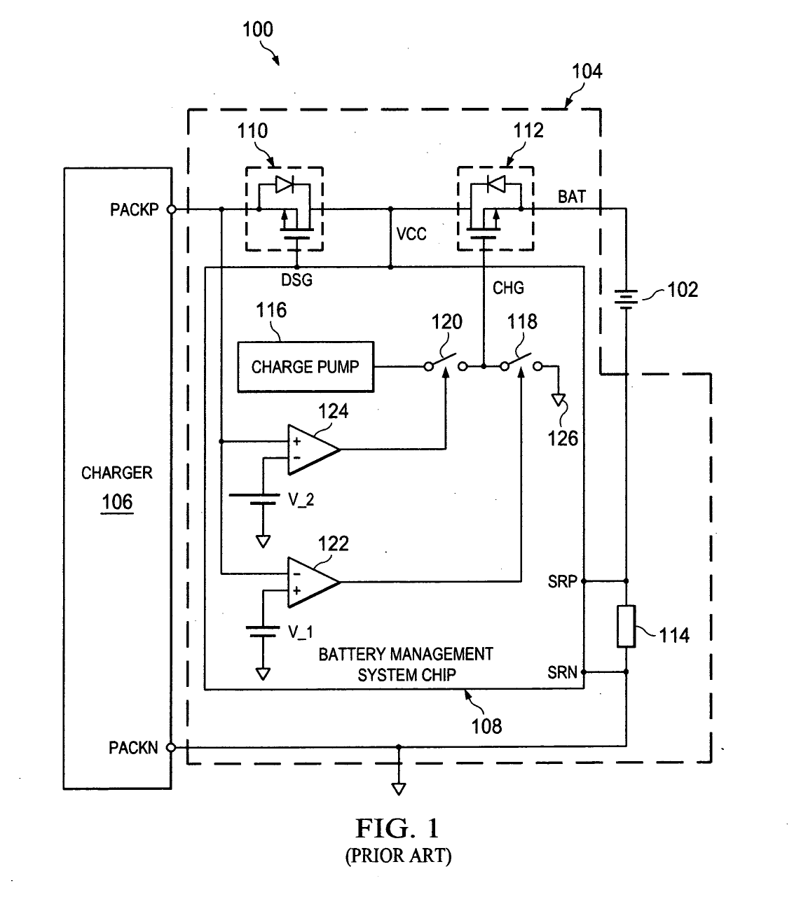

The structure and function of this embodiment is contrasted with the prior art discussed above (see FIG. 1) in which the switches 118 and 120 are operated to rapidly switch the connection to CHG back and forth between the ground 126 and the output of the charge pump 116. Rather than being “regulated”, however, the prior art charge pump 116 is always turned fully on. Therefore, switching the connection to CHG between the ground 126 and the output of the charge pump 116 results in the prior art battery management system chip 108 attempting to drive the gate of the charge FET 112 to full on and full off with each cycle during pulse width modulation.

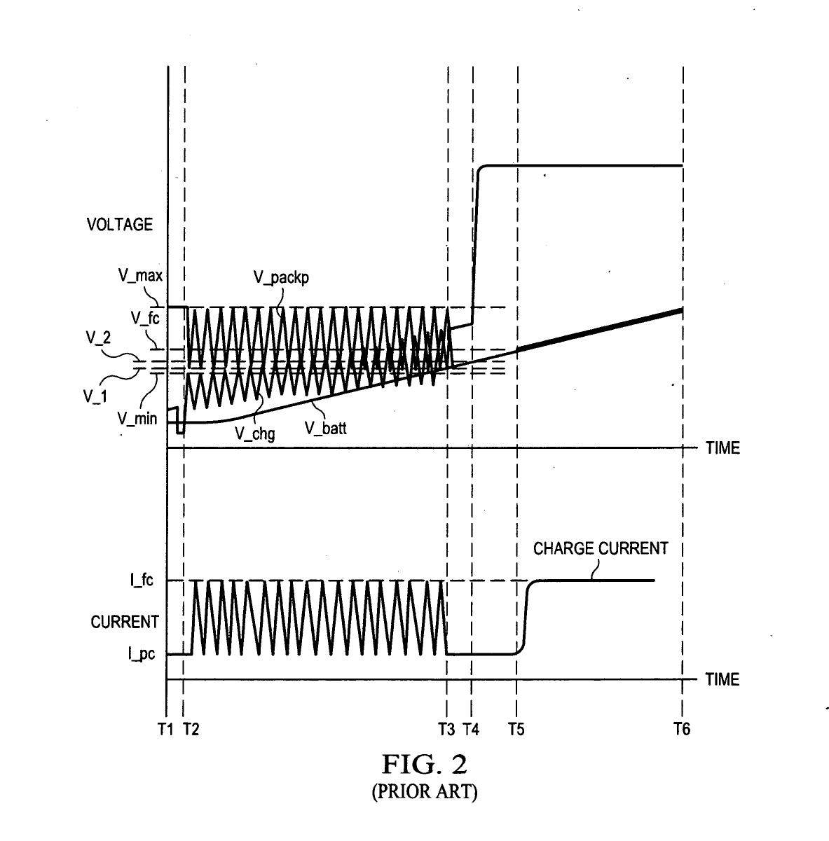

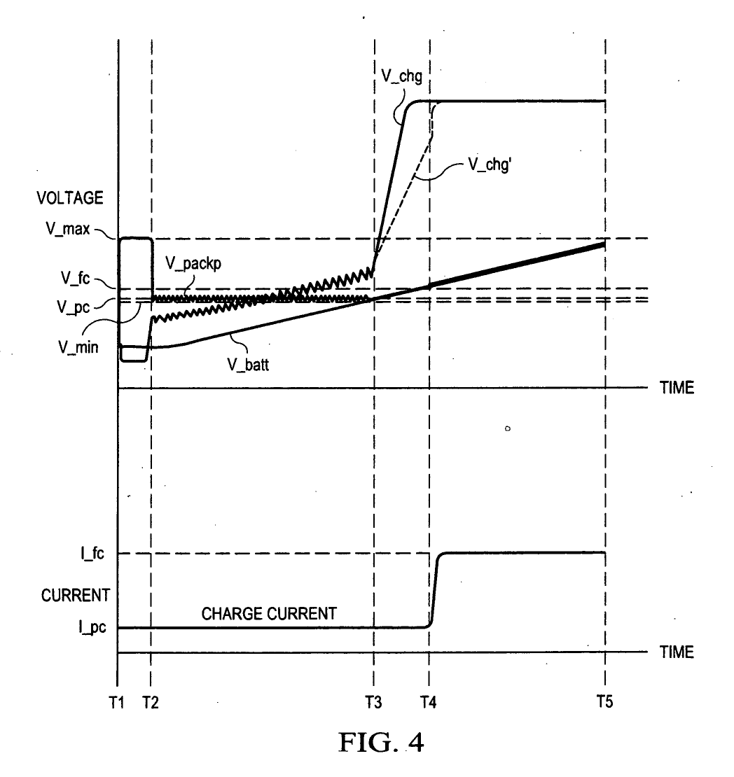

In the described embodiment of the present invention, however, since the CHG drive signal is regulated to change relatively slowly, compared to the prior art described above, the charge FET 210 increases and decreases the electrical connection between PACKP and BAT relatively slowly in response thereto. And since the electrical connection between PACKP and BAT changes relatively slowly, compared to the prior art described above, the voltage from the charger 206 at PACKP is pulled down and pulled up relatively slowly too. Additionally, since the voltage from the charger 206 at PACKP changes relatively slowly, compared to the prior art described above, the comparator 224 is able to respond to the changes in the voltage at PACKP (and the signal changes that result from the changes in the voltage at PACKP are able to propagate through the battery management system 204) before the voltage at PACKP can transition too far up or down. As a result, the voltage at PACKP appears to be relatively stable, almost a DC voltage, compared to the prior art voltage at PACKP (V_packp) shown in FIG. 2, as is described below with reference to FIG. 4.

The voltage and current graphs in FIG. 4 have been simplified or idealized in some respects in order to more clearly and easily illustrate certain aspects of embodiments of the present invention using an example that includes a representative pre-charge procedure, or method. It is understood, for example, that the graphs are not necessarily drawn to scale, but some portions thereof may be compressed or expanded or exaggerated to enhance some relationships between some of the graphs. Additionally, some portions of some of the graphs that appear to be linear may not necessarily be so linear. Other variations from potential real-world graphs may also be present.

In FIG. 4, the graph labeled V_batt illustrates a simplified response characteristic for the voltage of the battery 202 at BAT, in accordance with an embodiment of the present invention. The graph labeled V_packp illustrates a simplified response characteristic for the voltage from the charger 206 at PACKP, in accordance with an embodiment of the present invention. The graph labeled V_chg illustrates a simplified response characteristic for the CHG drive voltage applied to the gate of the charge FET 210, in accordance with an embodiment of the present invention. The graph segment labeled V_chg′ illustrates an alternative response characteristic for the CHG drive voltage applied to the gate of the charge FET 210, in accordance with an embodiment of the present invention. And the graph labeled charge current illustrates a simplified response characteristic for the current produced by the charger 206 (a “smart” charger, in this example, as defined above) to charge the battery 202, in accordance with an embodiment of the present invention.

Additionally, the voltage level labeled V_min represents an example level for the minimum operating voltage of the battery management system chip 212. The voltage level labeled V_pc represents an example level for the pre-charge threshold voltage. The voltage level labeled V_fc represents an example level for the fast-charge threshold voltage. The voltage level labeled V_max represents an example level for the maximum output voltage of the charger 206. The current level labeled I_pc represents an example level for the pre-charge current output by the charger 206. And the current level labeled I_fc represents an example level for the fast-charge current output by the charger 206.

Time T1 indicates a representative start time for connecting the charger 206 to the electronic device 200 to charge the battery 202. Between time T1 and time T2, the battery management system 204 powers up and voltages stabilize. The voltage from the charger 206 at PACKP (V_packp graph) during the T1-T2 interval goes high (up to V_max) to enable the electronic device 200 to power-up. The CHG drive voltage applied to the gate of the charge FET 210 (V_chg graph) remains low (almost zero) at first, which keeps the charge FET 210 turned off to prevent the voltage from the charger 206 at PACKP from being applied to the battery 202 before it can be determined whether the pre-charge mode must be used. The V_chg graph rises near the end of the T1-T2 interval as the CHG charge pump 222 begins to generate the CHG drive voltage to initially turn on the charge FET 210. (Not shown is the DSG drive voltage applied to the gate of the discharge FET 208, which goes high shortly before the CHG drive voltage.) The battery 202, for this example, is near fully discharged, so the voltage of the battery 202 at BAT (V_batt graph) is very low in the T1-T2 interval. The voltage of the battery 202 at BAT (V_batt graph) is not zero since it is assumed that the battery management system 204 does not allow the battery 202 to become fully depleted. Nevertheless, for this example, the voltage of the battery 202 is below the pre-charge threshold voltage V_pc. Additionally, the current from the charger 206 (charge current graph) preferably starts out at the lower pre-charge current level I_pc, since the charger 206 has not yet determined whether it can enter the fast-charge mode, and it is not desirable to apply the higher fast-charge current I_fc to the battery management system 204 or the battery 202 before this determination is made.

At about the beginning of the T2-T3 interval, the CHG drive voltage (V_chg graph) has come up sufficiently to turn on the charge FET 210 to establish a sufficient electrical connection between PACKP and BAT to enable the battery 202 to pull down the voltage at PACKP (V_packp graph). Since the initial voltage of the battery 202 (V_batt graph) is so low for this example, the voltage from the charger 206 at PACKP is pulled down below the fast-charge threshold V_fc, so the battery management system 204 enters the pre-charge mode, as described above. As a result, once the voltage at PACKP (V_packp graph) is further pulled down below the pre-charge threshold voltage V_pc, the voltage at PACKP (V_packp graph) begins to oscillate, or “ring” or “ripple”, a relatively small amount around the pre-charge threshold voltage V_pc, as described above. This ripple continues throughout the T2-T3 interval. Since the voltage from the charger 206 at PACKP is now connected to the battery 202, the voltage of the battery 202 at BAT (V_batt graph) begins to rise as the battery 202 begins to be re-charged. The CHG drive voltage applied to the gate of the charge FET 210 (V_chg graph) also rises relatively parallel to the V_batt graph, but with some oscillation due to the cycling of the CHG charge pump 222, described above. The charge current graph stays relatively steady at the pre-charge current level I_pc, albeit typically with some oscillations (not shown), during the T2-T3 interval.

At about time T3, The battery 202 has been re-charged sufficiently for the voltage of the battery 202 at BAT (V_batt graph) to reach the pre-charge threshold voltage V_pc. Consequently, the voltage at PACKP (V_packp graph) is no longer pulled down below the pre-charge threshold voltage V_pc. As a result, the voltage at PACKP (V_packp graph) no longer ripples above and below the pre-charge threshold voltage V_pc, since the comparator 224 and the CHG charge pump 222 no longer change their outputs. Therefore, the voltage at PACKP (V_packp graph) remains pulled down almost to (or negligibly higher than) the level of the voltage of the battery 202 at BAT (V_batt graph) during the T3-T4 interval. The voltage of the battery 202 at BAT (V_batt graph) continues to rise as the battery 202 continues to re-charge. Additionally, the CHG drive voltage applied to the gate of the charge FET 210 (V_chg graph) also generally stops oscillating at about T3, since the CHG charge pump 222 no longer changes its output. Instead, the CHG drive voltage applied to the gate of the charge FET 210 (V_chg graph) begins to rise steadily until it levels off at its maximum. Furthermore, the charge current graph continues relatively steady at the pre-charge current level I_pc, since the voltage at PACKP (V_packp graph) has not yet risen above the fast-charge threshold voltage V_fc, so the battery management system 204 and the charger 206 are still in the pre-charge mode.

At about time T4, the battery 202 has been re-charged sufficiently for the voltage of the battery 202 at BAT (V_batt graph) to reach the fast-charge threshold voltage V_fc. Consequently, the voltage at PACKP (V_packp graph) is no longer pulled down below the fast-charge threshold voltage V_fc. As a result, the charger 206 and the battery management system chip 212 detect that the fast-charge mode can be used. The charger 206, thus, begins to generate the fast-charge current, so the charge current graph rises from the pre-charge current level I_pc to the fast-charge current level I_fc immediately after time T4. In this example, the CHG drive voltage applied to the gate of the charge FET 210 (V_chg graph) already leveled off at its maximum in the T3-T4 interval, so there is no noticeable change in the V_chg graph. However, the V_chg′ graph illustrates a representative alternative situation in which the CHG charge pump 222 has not yet driven its output to the maximum output voltage by time T4. In such a situation, since the charger 206 and the battery management system chip 212 have switched to the fast-charge mode, the rate of increase of the CHG drive voltage applied to the gate of the charge FET 210 (V_chg′ graph) suddenly increases too, i.e. the slope of the V_chg′ graph increases at time T4, until the CHG drive voltage applied to the gate of the charge FET 210 (V_chg′ graph) levels off at its maximum. Additionally, due to the increased current from the charger 206, the voltage at PACKP (V_packp graph) makes a very slight increase above the level of the voltage of the battery 202 at BAT (V_batt graph), but remains generally parallel to the V_batt graph, after time T4. The voltage of the battery 202 at BAT (V_batt graph) continues to rise until the end of the battery charging procedure at time T5.

Although the graphs in FIGS. 2 and 4 are not necessarily drawn to scale, the amplitudes of the oscillations of the V_packp and V_chg graph segments in both Figures in the T2-T3 intervals fairly represent the relative difference between the two techniques, according to tests and simulations that have been done. For instance, in both cases, the V_max value was about 4.2 V, and the V_min value was about 2.0 V. In the prior art case (FIG. 2), however, the V fc value was about 2.8 V, while the V_fc value in the example in FIG. 4 was stricter at about 2.5 V. Additionally, the V_1 and V_2 values in FIG. 2 were about 2.2 V and 2.4 V, respectively, which allow for about a 200 mV margin above the V_min value. The V_pc value in FIG. 4, on the other hand, was about 2.1 V, which allows only for about a 100 mV margin above the V_min value, a much tighter restriction. Using the tighter restrictions illustrates that embodiments of the present invention can work better with the manufacturers' trend to make the fast-charge threshold voltage V_fc as low as possible and effectively “squeeze” V_fc and V_min into a narrower and narrower range.

The prior art V_chg graph segment in FIG. 2 exhibits an amplitude swing of up to about 1.9 V. Additionally, the prior art V_packp graph segment exhibits an amplitude swing of up to about 2.0 V. In order to produce the prior art V_packp and V_chg graph segments with these amplitude swings with the above example settings, the prior art example of FIGS. 1 and 2 had to be driven with enough power to achieve about a 2 micro-second response time for the performance of the components thereof.

The V_chg graph segment in FIG. 4, on the other hand, exhibits an amplitude swing of up to only about 0.25 V to 0.4 V, almost a five-fold to eight-fold improvement over the prior art example. Additionally, the V_packp graph segment in FIG. 4 exhibits an amplitude swing of up to only about 200 mV (2.2 V-2.0 V), an order of magnitude, or ten-fold, improvement over the prior art example. Furthermore, in order to produce the representative V_packp and V_chg graph segments with these amplitude swings with the above settings, the embodiment of FIGS. 3 and 4 had to be driven with enough power to achieve only about a 10-100 micro-second (or, alternatively, about a 20 micro-second) response time for the performance of the components (e.g. the CHG charge pump 222) thereof, a significant improvement over the prior art example, which allows for cheaper (i.e. slower response time and lower power-consuming) components. In other words, in spite of the more lenient settings used in the prior art example of FIGS. 1 and 2 to generate the prior art graphs of FIG. 2, the representative embodiment of FIGS. 3 and 4 required less power and fewer and cheaper components to achieve a superior result.

It is understood that the values used in the above prior art example (FIGS. 1 and 2) and the embodiment of the present invention (FIGS. 3 and 4) are representative only and are presented for illustrative purposes only. The invention is not necessarily limited to these values, except where called for in the claims.

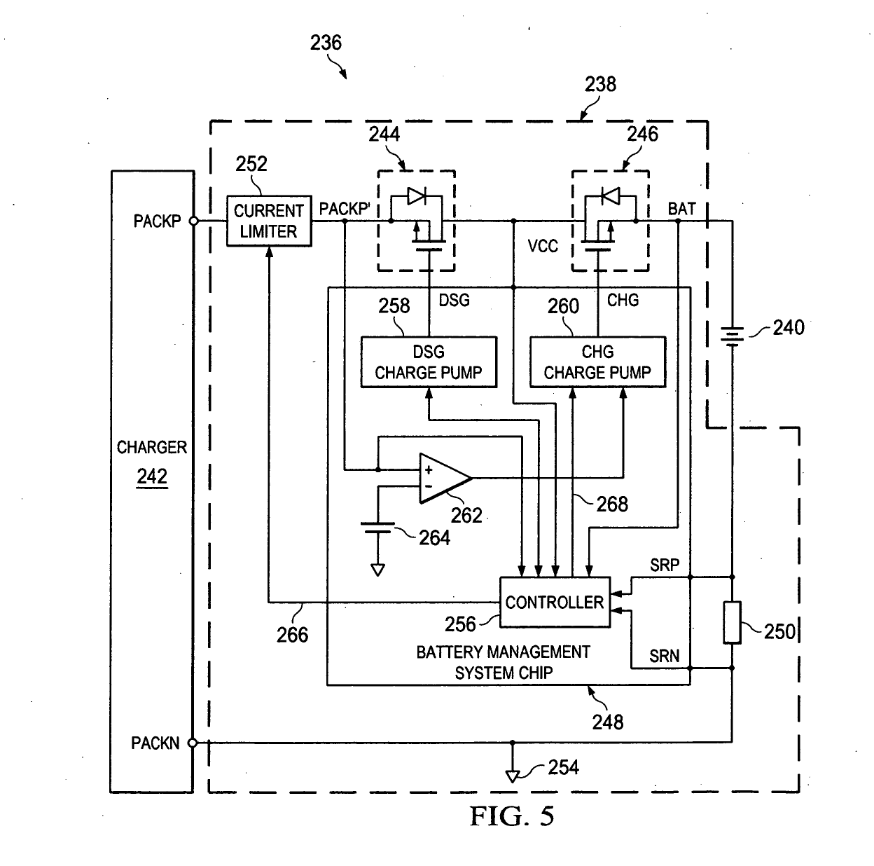

FIG. 5 illustrates an alternative electronic device 236 that includes some representative alternative designs for portions thereof. In this embodiment, for example, an alternative embodiment battery management system 238 controls the charging of a battery 240 by a charger 242. In some of the alternatives, the charger 242 is not a “smart” charger, as described above, that can sense the voltage level at its output and can adjust the output current accordingly to enter either the pre-charge mode or the fast-charge mode. Instead, the charger 242, such as some simple DC/DC converters, outputs a single current level. The battery management system 238 for this alternative, therefore, is adapted to limit the current when necessary for the pre-charge mode.

The battery management system 238 generally includes a discharge FET 244, a charge FET 246, a battery management system chip 248, a sense resistor 250 and a current limiter circuit 252. The discharge FET 244 and the charge FET 246 may be similar to the discharge FET 208 and the charge FET 210, respectively, of the embodiment shown in FIG. 3. Additionally, the discharge FET 244 and the charge FET 246 may be connected to VCC, BAT, DSG and CHG similar to the discharge FET 208 and the charge FET 210. However, the discharge FET 244 is preferably connected to an output of the current limiter circuit 252 at PACKP′, instead of directly to the output of the charger 242 at PACKP. The current limiter circuit 252, on the other hand, is connected to the output of the charger 242 at PACKP, so as to limit the current from the charger 242 when necessary for pre-charge mode. Additionally, the battery 240 is preferably connected to the charge FET 246 and the sense resistor 250, similar to the battery 202 shown in FIG. 3. And the sense resistor 250, similar to the sense resistor 214 shown in FIG. 3, is preferably connected to the SRP node and the SRN node of the battery management system chip 248, to ground 254 and to a return line of the charger 242 at PACKN.

The battery management system chip 248 generally has a controller 256, a DSG (discharge) charge pump 258, a CHG (charge) charge pump 260, a comparator 262 and a reference voltage 264, which may be similar to the controller 218, the DSG charge pump 220, the CHG charge pump 222, the comparator 224 and the reference voltage 234, respectively, shown in FIG. 3, except as described herein. The controller 256 receives the voltage at either PACKP′ (as shown) or PACKP and/or at BAT in order to determine, as described above with respect to the controller 218, whether to use the pre-charge mode or the fast-charge mode. The controller 256 asserts a limit current signal 266 to the current limiter circuit 252 when it determines that the pre-charge mode is to be used. In response to assertion of the limit current signal 266, the current limiter circuit 252 limits the current from the charger 242 to the lower pre-charge current, but preferably maintains the voltage at PACKP′ at about the same level as the voltage at PACKP.

The limit current signal 266 may be the PWM_EN signal 230 (FIG. 3) in alternative embodiments in which the CHG charge pump 260 and the comparator 262 are essentially the same as the CHG charge pump 222 and the comparator 224, respectively, (FIG. 3) and the controller 256 generates the PWM_EN signal 230 and the CHG charge pump enable signal 228 to control the CHG charge pump 260 and the comparator 262, as described above. In such an embodiment, in other words, the PWM_EN signal 230 would control the CHG charge pump 260, the comparator 262 and the current limiter circuit 252 to put the battery management system 238 in the pre-charge mode.

In the alternative embodiment shown in FIG. 5, however, the controller 256 does not generate the PWM_EN signal 230. Therefore, the limit current signal 266 is separately generated by the controller 256 (depending on the voltage at PACKP′, PACKP or BAT) to cause the current limiter circuit 252 to limit the charge current to the lower pre-charge current. Additionally, according to another alternative, instead of using the PWM_EN signal 230 and a CHG charge pump enable signal (e.g. 228 above) to control the CHG charge pump 260, a single enable signal 268 is used to control the CHG charge pump 260. And instead of using the PWM_EN signal 230 to control the comparator 262, the comparator 262 is simply always on. In this alternative, therefore, the comparator 262 switches its output as the voltage at PACKP′ (or PACKP) rises and falls above and below the pre-charge threshold voltage (i.e. the reference voltage 264), but maintains a steady output once the voltage of the battery 240 at BAT increases sufficiently that the voltage at PACKP′ (or PACKP) no longer falls below the pre-charge threshold voltage. Additionally, the CHG charge pump 260 increases and decreases its output, as described above, in response to the output of the comparator 262. And after the comparator 262 stops changing its output, the CHG charge pump 260 maintains its response characteristic regardless of whether the battery management system 238 is in the pre-charge or fast-charge mode. Therefore, this alternative may be used, for example, in embodiments in which it is sufficient for the action of the CHG charge pump 260 to remain the same during the fast-charge mode as it is during the pre-charge mode, and the power consumed by the comparator 262 is insignificant even when the comparator 262 is not needed for changing its output.

Embodiments that work with a smart charger (FIG. 3) may incorporate either of the alternatives of including (FIG. 3) or not including (FIG. 5) the PWM_EN signal 230. And embodiments that do not use a smart charger (FIG. 5) may also incorporate either of the alternatives of including (FIG. 3) or not including (FIG. 5) the PWM_EN signal 230.

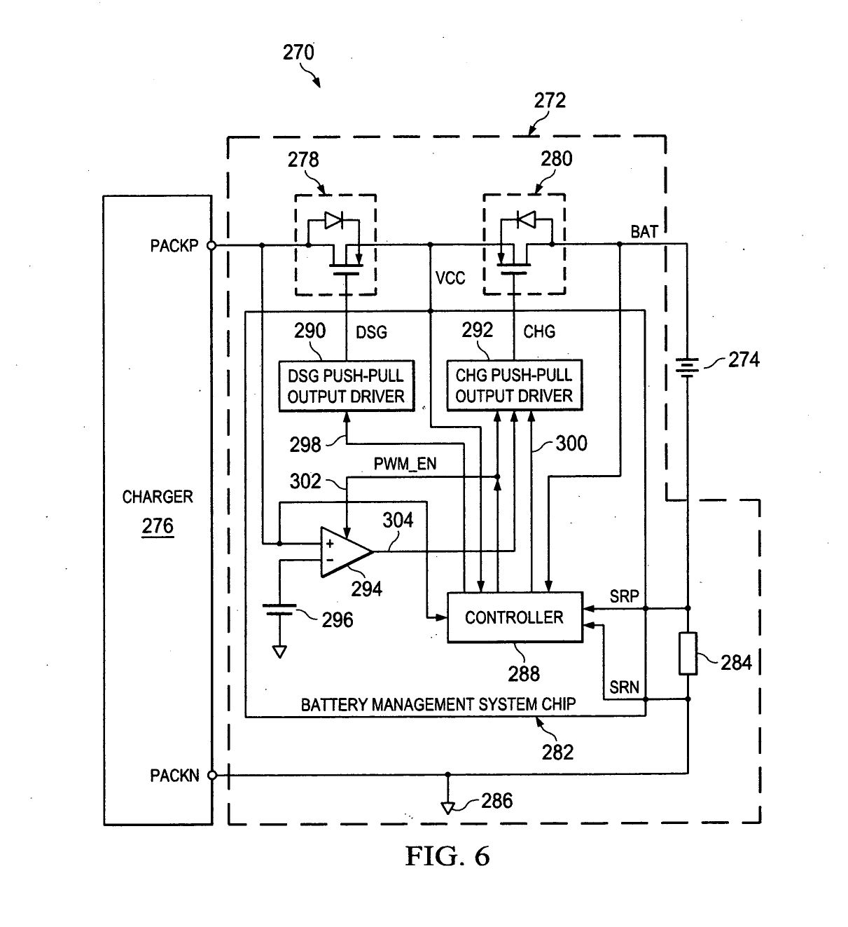

FIG. 6 illustrates another alternative electronic device 270 that includes some additional alternative designs for portions thereof. In this embodiment, for example, another alternative battery management system 272 controls the charging of a battery 274 by a charger 276. The alternative battery management system 272 generally includes a discharge FET 278, a charge FET 280, a battery management system chip 282 and a sense resistor 284.

In the embodiments illustrated in FIGS. 3 and 5, the discharge FETs 208 and 244 and the charge FETs 210 and 246 are depicted as NMOS FETs. In the embodiment of FIG. 6, however, the discharge FET 278 and the charge FET 280 are shown as PMOS FETs.

The discharge FET 278 and the charge FET 280 may be connected to the PACKP, VCC, BAT, DSG and CHG nodes as shown. Additionally, the battery 240 is preferably connected to the charge FET 280 and the sense resistor 284, similar to the batteries 202 and 240 shown in FIGS. 3 and 5. And the sense resistor 284, similar to the sense resistors 214 and 250 shown in FIGS. 3 and 5, is preferably connected to the SRP node and the SRN node of the battery management system chip 282, to ground 286 and to a return line of the charger 276 at PACKN.

In this embodiment, the charger 276 is assumed to be a smart charger, as described above, since the battery management system 272 is not adapted to limit the current when necessary for the pre-charge mode. Therefore, no current limiter circuit (e.g. 252 in FIG. 5) is shown. However, it is understood that the embodiment shown in FIG. 6 could be adapted to include such a current limiter 252 in order to work with a charger that is not a smart charger.

The battery management system chip 282 generally includes a controller 288, a DSG (discharge) push-pull output driver 290, a CHG (charge) push-pull output driver 292, a comparator 294 and a reference voltage 296. The controller 288, the comparator 294 and the reference voltage 296 are similar to the controller 218, the comparator 224 and the reference voltage 234 described above with reference to FIG. 3. Additionally, input signals from PACKP, VCC, BAT, SRP and SRN to the controller 288 in FIG. 6 are similar to the input signals from PACKP, VCC, BAT, SRP and SRN to the controller 218 in FIG. 3. Furthermore, DSG push-pull output driver enable signal 298, CHG push-pull output driver enable signal 300, PWM_EN signal 302 and control signal 304 in FIG. 6 are similar to the control and enable signals 226, 228, 230 and 232, respectively, in FIG. 3.

Since the discharge FET 278 and the charge FET 280 are PMOS FETs, instead of NMOS FETs, it is preferable to use the DSG and CHG push-pull output drivers 290 and 292, instead of charge pumps, to produce the gate drive signals at DSG and CHG, respectively, to drive the discharge FET 278 and the charge FET 280, respectively. The DSG push-pull output driver 290 drives the gate of the discharge FET 278, in response to the DSG push-pull output driver enable signal 298, with an overall similar result in the function of the discharge FET 278 as in the function of the discharge FET 208 or 244 (FIG. 3 or 5), as described above. Additionally, the CHG push-pull output driver 292 drives the gate of the charge FET 280, in response to the CHG push-pull output driver enable signal 300, the PWM_EN signal 302 and the control signal 304, with an overall similar result in the function of the charge FET 280 as in the function of the charge FET 210 or 246 (FIG. 3 or 5), as described above. Therefore, whereas the CHG push-pull output driver 292 responds to the CHG push-pull output driver enable signal 300 by turning on the charge FET 280 as quickly as possible, the CHG push-pull output driver 292 responds (by conventional means) to the PWM_EN signal 302 and the control signal 304 by more slowly turning on and off the charge FET 280. In other words, the CHG push-pull output driver 292 is used during pre-charging in a “regulated” mode in which it turns on and off the charge FET 280 relatively gradually. In this manner, the battery management system 272 achieves a relatively stable, almost-DC-voltage in the voltage at PACKP, similar to the V_packp graph in FIG. 4, using PMOS FETs, instead of NMOS FETs.

The invention claimed is:

1. A battery management system for charging a battery by a charger, comprising:
a management chip having a controller, a comparator and one of a charge pump and a push-pull output driver, the management chip is for connecting to a voltage from the charger and to the battery, wherein the controller turns on an enable signal in response to a voltage of the battery being below a fast-charge threshold voltage, the comparator turns on a control signal in response to the enable signal being on and to the voltage from the charger being above a pre-charge threshold voltage, the comparator turns off the control signal in response to the enable signal being on and to the voltage from the charger being below the pre-charge threshold voltage, the one of the charge pump and the push-pull output driver increases a drive signal in response to the enable and control signals being on, and the one of the charge pump and the push-pull output driver decreases the drive signal in response to the enable signal being on and the control signal being off; and
a transistor connected external to the management chip to receive the drive signal at a gate, the transistor is also for connecting to the voltage from the charger and to the battery, wherein as the one of the charge pump and the push-pull output driver increases the drive signal the transistor increases an electrical connection between the battery and the voltage from the charger which causes the voltage from the charger to be pulled down towards the voltage of the battery and to charge the battery with a pre-charge current as long as the voltage of the battery is below the fast-charge threshold voltage, and as the one of the charge pump and the push-pull output driver decreases the drive signal the transistor decreases the electrical connection between the battery and the voltage from the charger which causes the charger to pull the voltage from the charger up towards a charger output voltage.

2. The battery management system of claim 1, wherein:
the system cycles between turning on and off the transistor and pulling down and up the voltage from the charger alternately below and above the pre-charge threshold voltage without pulling the voltage from the charger below a minimum voltage or above the fast-charge threshold voltage while the voltage of the battery is below the pre-charge threshold voltage;
the system turns on the transistor with a 100% duty cycle and charges the battery with the pre-charge current while the voltage of the battery is between the pre-charge threshold voltage and the fast-charge threshold voltage; and
the system turns on the transistor with a 100% duty cycle and charges the battery with a fast-charge current from the charger while the voltage of the battery is above the fast-charge threshold voltage.

3. The battery management system of claim 1, wherein:
while the voltage of the battery is below the pre-charge threshold voltage, the one of the charge pump and the push-pull output driver has a response time of about 10-100 micro-seconds.

4. The battery management system of claim 1, wherein:
while the voltage of the battery is below the pre-charge threshold voltage, the one of the charge pump and the push-pull output driver has a response time of about 20 micro-seconds.

5. The battery management system of claim 1, wherein:
the drive signal from the one of the charge pump and the push-pull output driver varies by less than about 400 mV during a time period in which the voltage from the charger cycles above and below the pre-charge threshold voltage.

6. The battery management system of claim 1, wherein:
while the voltage of the battery is below the pre-charge threshold voltage, the voltage from the charger varies by no more than about +/−100 mV.

7. The battery management system of claim 6, wherein:
while the voltage of the battery is below the pre-charge threshold voltage, the voltage from the charger varies by no more than about +/−100 mV from the pre-charge threshold voltage.

8. The battery management system of claim 7, wherein:
the pre-charge threshold voltage is about 2.1 V.

9. A battery management system for charging a battery by a charger, comprising:
a transistor that transmits a charge current from the charger to the battery by turning on and off in response to a pulse width modulated drive signal; and
one of a charge pump and a push-pull output driver that generates the drive signal, the one of the charge pump and the push-pull output driver increases the drive signal when a voltage from the charger is above a pre-charge threshold voltage and decreases the drive signal when the voltage from the charger is below the pre-charge threshold voltage.

10. The battery management system of claim 9, further comprising:
a comparator that generates a control signal based on the voltage from the charger and the pre-charge voltage threshold during a pre-charge procedure;
and wherein the one of the charge pump and the push-pull output driver increases and decreases the drive signal based on the control signal.

11. The battery management system of claim 9, wherein:
in a regulated mode the one of the charge pump and the push-pull output driver has a response time of about 20 micro-seconds.

12. The battery management system of claim 9, wherein:
the drive signal generated by the one of the charge pump and the push-pull output driver varies by about 250 to 400 mV during a time period in which the voltage from the charger cycles above and below the pre-charge threshold voltage.

13. The battery management system of claim 9, wherein:
the voltage from the charger varies by no more than about 100 mV above or below the pre-charge voltage threshold during a time period in which a voltage of the battery is below the pre-charge voltage threshold.

14. The battery management system of claim 9, wherein:
the voltage from the charger varies between about 2.2 V and about 2.0 V during a time period in which a voltage of the battery is below the pre-charge voltage threshold.

15. A method for charging a battery, comprising:
generating a comparator output signal that depends on whether a voltage from a charger is above or below a threshold voltage;
one of a charge pump and a push-pull output driver generating a pulse width modulated (PWM) output voltage, the one of the charge pump and the push-pull output driver increasing and decreasing the PWM output voltage in response to the comparator output signal;
driving a transistor with the PWM output voltage to increase and decrease an electrical connection between the battery and the voltage from the charger;
decreasing the voltage from the charger to below the threshold voltage by driving the transistor to increase the electrical connection between the battery and the voltage from the charger; and
increasing the voltage from the charger to above the threshold voltage by driving the transistor to decrease the electrical connection between the battery and the voltage from the charger.

16. The method of claim 15, wherein:
the increasing and decreasing of the voltage from the charger maintains the voltage from the charger within a range within which a pre-charge current charges the battery in a pre-charge mode.

17. The method of claim 16, wherein:
the range within which the voltage from the charger is maintained is about +/−100 mV of the threshold voltage during a time period in which a voltage of the battery is below the threshold voltage.

18. The method of claim 17, wherein:
the threshold voltage is about 2.1 V.

19. The method of claim 15, wherein:
the increasing and decreasing of the PWM output voltage occurs with a response time of about 20 micro-seconds.

20. The method of claim 15, wherein:
the PWM output voltage varies by about 250 to 400 mV during a time period in which the voltage from the charger cycles above and below the threshold voltage.
